(19) United States
(12) Patent Application Publication
(10) Pub. No.: US 2026/0010092 A1
(43) Pub. Date: Jan. 8, 2026

(54) IMAGE FORMING APPARATUS

(71) Applicant: CANON KABUSHIKI KAISHA, Tokyo (JP)

(72) Inventors: AKIHISA MATSUKAWA, Tokyo (JP); KAZUNARI HAGIWARA, Kanagawa (JP); YASUKAZU IKAMI, Tokyo (JP); HIROKI TANAKA, Kanagawa (JP)

(21) Appl. No.: 19/245,621

(22) Filed: Jun. 23, 2025

(30) Foreign Application Priority Data
Jul. 4, 2024 (JP) 2024-108035

(51) Int. Cl. G03G 15/02; G03G 15/00; G03G 21/18

(52) U.S. Cl. CPC G03G 15/0266; G03G 15/0233; G03G 15/80; G03G 21/1814; G03G 21/1867; G03G 2215/021

(57) ABSTRACT

An image forming apparatus includes a drum, a first charger configured to charge at a first charging portion between the drum and the first charger in response to application of a first charging voltage, a developing roller configured to supply a developer to the drum at a developing portion, a second charger configured to form a second charging portion downstream of the first charging portion and upstream of the developing portion in drum rotation direction, and to charge by discharge at the second charging portion in response to application of a second charging voltage, and a controller configured to control voltage application, and the controller is configured to control such that the second charging voltage to start discharge is applied to the second charger during the rotation of the drum and after application of the first charging voltage.

### BACKGROUND

### Field of the Technology

The present technology relates to an image forming apparatus.

### Description of the Related Art

Examples of conventional image forming apparatuses of the electrophotographic type or the electrostatic recording type include laser printers, copiers, and facsimile machines. In recent years, contact charging devices have been used as charging unit for photosensitive drums, such as electrophotographic photoconductors and electrostatic recording dielectrics, in these image forming apparatuses. The contact charging device operates according to a method in which a charging member, to which a voltage is applied, is brought into contact with the photosensitive drum, and this offers advantages such as low ozone emission and low power consumption.

Among the contact charging methods, the roller charging method using a charging roller as a charging member is preferable from the standpoint of charging stability. In the roller charging method, an elastic roller having a medium resistance as a charging member is pressed against the photosensitive drum, and a voltage is applied to the charging member to charge the photosensitive drum. Specifically, since the charging processing is performed by discharge from the charging member to the photosensitive drum, the charging is started by applying a voltage equal to or higher than a threshold voltage to the charging member according to the Paschen's law.

The contact charging type charging device generates a trace amount of discharge products due to a discharge phenomenon from a charging member to a photosensitive drum. The surface of the photosensitive drum is altered by the discharge phenomenon. The discharge products and the altered part of the photosensitive drum surface tend to become less resistant, especially in high-temperature and high-humidity environments. As a result, the surface potential necessary for image formation may not be formed on the photosensitive drum, which may make it difficult for the developing roller to develop intended images. Therefore, it is necessary to address the generation of discharge products and the alteration of the photosensitive drum surface without relying on abrasion of the drum surface.

Japanese Patent Laid-Open No. H07-005748 discloses a charging method that does not involve a discharge phenomenon. Japanese Patent Laid-Open No. H07-005748 discloses a method for charging a photosensitive drum by providing a charge injection layer on the outermost surface of the photosensitive drum and directly injecting charges to the photosensitive drum from a charging brush. In this configuration, unlike charging methods that use discharge, the charging member comes into direct contact with the photosensitive drum to inject charges, thereby suppressing the generation of discharge products and alteration of the photosensitive drum surface that may be caused by the discharge. However, compared with contact charging methods using discharge, the charge uniformity may be insufficient, potentially resulting in image defects.

In order to solve such a problem, Japanese Patent Laid-Open No. 2023-056470 discloses a combination of a charge injection method that does not use discharge and a contact charging method that uses discharge. In this configuration disclosed in Japanese Patent Laid-Open No. 2023-056470, a certain level of potential is formed by charge injection on the upstream side, in the rotational direction, of the photosensitive drum (first charging unit) and a prescribed level of potential is then formed on the downstream side by the contact charging method that uses discharge (second charging unit). In this way, compared with the case where the potential of the photosensitive drum is formed solely by discharge, the amount of discharge products generated, and the alteration of the photosensitive drum can be reduced. Since the final charging is performed by discharge, the adverse effects of charge non-uniformity due to injection charge are also suppressed.

### SUMMARY

However, Japanese Patent Laid-Open No. 2023-056470 discloses the following problems which may be encountered. In the configuration disclosed in Japanese Patent Laid-Open No. 2023-056470, at the start of driving the photosensitive drum, the amount of discharge in the second charging unit tends to increase, which could lead to the generation of discharge products and alteration of the surface of the photosensitive drum.

The present disclosure has been made in view of the above-described issues. The present disclosure is directed to suppress the occurrence of adverse effects associated with discharge in an image forming apparatus in which charge injection and contact charging methods are used in combination when charging a photosensitive drum.

The present disclosure provides an image forming apparatus comprising:
a photosensitive drum configured to be rotatable;
a first charging member configured to oppose the photosensitive drum to form a first charging portion, and to charge a surface of the photosensitive drum at the first charging portion in response to application of a first charging voltage thereto;
a developing roller configured to oppose the photosensitive drum to form a developing portion, and to supply a developer to the photosensitive drum at the developing portion;
a second charging member configured to oppose the photosensitive drum, in a position downstream of the first charging portion and upstream of the developing portion in a rotational direction of the photosensitive drum, to form a second charging portion, and to charge a surface of the photosensitive drum by discharge at the second charging portion in response to application of a second charging voltage of at least a discharge start threshold thereto; and
a control unit configured to control application of the first charging voltage to the first charging member and application of the second charging voltage to the second charging member, so that only a DC voltage is applied as the first charging voltage and the second charging voltage,
   wherein
the control unit is configured to perform control such that the second charging voltage, which is equal to or greater than a threshold for start of discharge from the second charging member, is applied to the second charging member during rotation of the photosensitive drum and after application of the first charging voltage to the first charging member.

According to the present disclosure, in an image forming apparatus that uses both injection charging and contact charging methods when charging a photosensitive drum, adverse effects associated with discharge can be suppressed.

Features of the present disclosure will become apparent from the following description of embodiments with reference to the attached drawings. The following description of embodiments are described by way of example.

### BRIEF DESCRIPTION OF THE DRAWINGS

FIG. 1 is a view for illustrating an uncharged region in Example 1;

FIG. 2 is a schematic view of an image forming apparatus and a process cartridge in Example 1;

FIG. 3 is a control block diagram for illustrating Example 1;

FIG. 4 is a graph for illustrating the relationship between the surface potential of the photosensitive drum and applied voltage in Example 1;

FIGS. 5A and 5B are schematic views of the layered structure of the photosensitive drum in Examples 1 and 2;

FIG. 6 illustrates the timing of charge application and the amount of discharge in Comparative Example 1;

FIG. 7 illustrates the timing of charge application and the amount of discharge in Comparative Example 2;

FIG. 8 illustrates the timing of charge application and the amount of discharge in Comparative Example 3;

FIG. 9 illustrates the timing of charge application and the amount of discharge in Example 1;

FIG. 10 illustrates the timing of charge application and the amount of discharge in Example 2;

FIG. 11 illustrates the timing of charge application and the amount of discharge in Example 3;

FIG. 12 illustrates the timing of charge application and the amount of discharge in Example 4;

FIG. 13 is a schematic view of an image forming apparatus and a process cartridge in Example 5;

FIG. 14 illustrates the timing of charge application in Example 5;

FIG. 15 is a schematic cross-sectional view of an image forming apparatus and a process cartridge in Modification 1;

FIG. 16 is a schematic cross-sectional view of an image forming apparatus and a process cartridge in Example 6;

FIG. 17 illustrates the timing of charge application in Example 6;

FIG. 18 is a schematic cross-sectional view of an image forming apparatus and a process cartridge in Modification 2;

FIG. 19 illustrates the timing of charge application and the amount of discharge in Example 7;

FIG. 20 illustrates the timing of charge application and the amount of discharge in Example 8; and

FIG. 21 illustrates the timing of charge application and the amount of discharge in Example 9.

### DESCRIPTION OF THE EMBODIMENTS

Hereinafter, embodiments for carrying out the disclosure will be described in detail, by way of illustration, on the basis of examples and with reference to the accompanying drawings. However, the dimensions, materials, shapes, and relative arrangement of the components described in the embodiments may be changed as appropriate, depending on the configuration of the apparatus to which the disclosure is applied and various conditions. In other words, the scope of the disclosure is not intended to be limited to the following embodiments.

### Example 1

### 1. Image Forming Apparatus

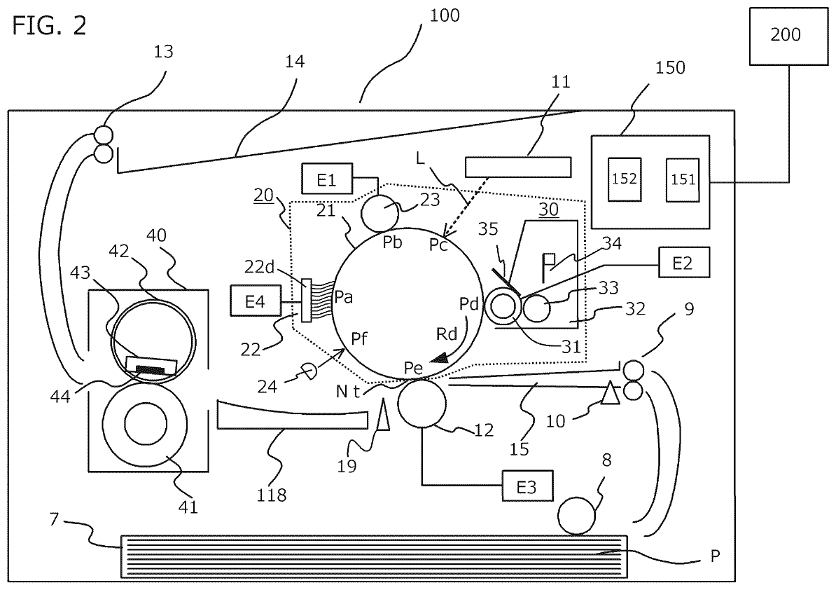

FIG. 2 is a sectional view of an overall configuration of an image forming apparatus 100. The image forming apparatus 100 of the present example is an electrophotographic laser printer and can form an image on a recording material P in accordance with image information input from an external device 200 such as a personal computer. The configuration of the image forming apparatus 100 will be described.

The image forming apparatus 100 mainly includes a scanner unit 11, a transfer roller 12, a fixation apparatus 40, and a control unit 150. An electrophotographic process cartridge 20 may be detachably provided to the image forming apparatus 100. The process cartridge 20 includes a photosensitive drum 21, a charging brush 22 disposed around the photosensitive drum 21, a charging roller 23, and a developing apparatus 30 including a developing roller 31. The transfer roller 12 transfers a toner image formed on the photosensitive drum 21 of the process cartridge 20 to the recording material P.

The photosensitive drum 21 is a cylindrical photoreceptor. The photosensitive drum 21 as the image bearing member is driven to rotate in a prescribed direction (clockwise direction Rd in FIG. 2) at a prescribed process speed by the drive motor 120. In the image forming apparatus 100 of the present example, the printing speed when continuously feeding A4-size sheets is 30 pages per minute, and the circumferential surface of the photosensitive drum 21 rotates at 170 mm/s. The charging brush 22 and the charging roller 23 are in contact with the photosensitive drum 21 with a prescribed contact pressure.

When a desired voltage is applied to the charging brush 22 and the charging roller 23, the surface of the photosensitive drum 21 is uniformly charged to a prescribed potential. In this example, the photosensitive drum 21 is charged by the charging brush 22 at a first charging position Pa (a first charging section formed between the charging brush 22 and the photosensitive drum 21) (first charging processing). The photosensitive drum 21 is charged by the charging roller 23 at a second charging position Pb (a second charging portion formed between the charging roller 23 and the photosensitive drum 21) to a final drum surface potential required for image formation (second charging processing). In the example, the final drum surface potential is −500 V. The charging of the photosensitive drum 21 will be described in detail in the section “5. Charging Configuration”. It should be noted that the charging power source E1 to the blade power source E5 may be provided as respective independent power supplies, or one or more power supplies may be capable of applying voltages to multiple targets.

The scanner unit 11 as an exposure unit irradiates the photosensitive drum 21 with a laser beam L corresponding to image information input from the external device 200 using a polygon mirror. By scanning and exposing the surface of the photosensitive drum 21 in this manner, an electrostatic latent image corresponding to image information is formed on the surface of the photosensitive drum 21. In this example, the drum surface potential of the solid black portion (exposed portion Pc) drops to −50 V by laser exposure carried out by the scanner unit 11. The scanner unit 11 is not limited to such a laser scanner device. For example, an LED exposure apparatus having an LED array in which a plurality of LEDs are arranged in the longitudinal direction of the photosensitive drum 21 may be used.

Next, the process cartridge 20 will be described. The process cartridge 20 has the developing apparatus 30. The developing apparatus 30 includes the developing roller 31 as a developer carrier, a developing container 32 as the frame body of the developing apparatus 30, and a supply roller 33 capable of supplying a developer to the developing roller 31. The developing roller 31 and the supply roller 33 are rotatably supported by the developing container 32. The developing roller 31 is provided at the opening of the developing container 32 to oppose the photosensitive drum 21. The supply roller 33 is rotatably in contact with the developing roller 31. The toner as the developer stored in the developing container 32 is supplied to the surface of the developing roller 31 by the supply roller 33.

In the present example, the developing apparatus 30 uses contact development as its development method. That is, the toner layer carried on the developing roller 31 comes into contact with the photosensitive drum 21 in a developing region (developing portion Pd) where the photosensitive drum 21 and the developing roller 31 are opposed to each other. A developing voltage is applied to the developing roller 31 by the developing power source E2 as a developing voltage applying unit. Under the condition where a development voltage is applied, the toner carried on the developing roller 31 is transferred from the developing roller 31 to the surface of the photosensitive drum 21 in accordance with the potential distribution on the surface of the photosensitive drum 21, so that the electrostatic latent image is developed into a toner image.

In the present example, the developing voltage is −300 V. In the present example, reversal developing is used. In reversal development, the surface of the photosensitive drum 21 is first charged in a charging step. Subsequently, in the exposure step, the surface of the photosensitive drum 21 is exposed. At the time, the amount of charge decreases in the exposed portion of the surface of the photosensitive drum 21 irradiated with the laser beam L. Then, toner supplied from the developing roller 31 adheres to the exposure area, thereby forming a toner image.

In the present example, toner having an average particle diameter of 7 μm and a normal charge polarity of negative is used. The toner is a polymerized toner produced by polymerization. The toner does not contain a magnetic component and is a so-called nonmagnetic single-component developer, in which the toner is mainly carried on the developing roller 31 by intermolecular force and electrostatic force (image force).

The toner particles contain a plurality of waxes for adjusting the melting characteristics of the toner during the fixation processing and the adhesion to the printing medium and the fixing roller. Fine silica particles having a submicron-order particle size are added to the surfaces of the toner particles to adjust the fluidity and charging characteristics of the toner. In the present example, the toner to which fine particles are added is defined as the developer.

In the present example, a nonmagnetic single-component developer is given as an example, but a single-component developer containing a magnetic component may also be used. Alternatively, a two-component developer composed of nonmagnetic toner and a magnetic carrier may be used as the developer. When a magnetic developer is used, a cylindrical developing roller 31 having a magnet provided inside is used as the developer carrier, for example.

Inside the developing container 32, a stirring member 34 is provided as stirring unit. The stirring member 34 is driven by the drive motor 120 to rotate, thereby stirring the toner in the developing container 32 and feeding the toner toward the developing roller 31 and the supply roller 33. The stirring member 34 serves to circulate, within the developing container, unused toner scraped off from the developing roller 31, thereby homogenizing the toner within the container.

The developing blade 35 made of a stainless steel plate is provided at the opening of the developing container 32 where the developing roller 31 is provided to regulate the amount of the toner carried on the developing roller 31. A voltage 200 V higher in absolute value on the negative polarity side than that of the developing roller 31 is applied to the developing blade 35 from the blade power source E5. That is, a voltage of −500 V, which is 200 V greater on the normal polarity side of the toner, is applied to the developing blade 35.

The toner supplied onto the surface of the developing roller 31 is formed into a uniform thin layer as it passes through the area opposed to the developing blade 35 in accordance with the rotation of the developing roller 31. At the same time, the toner is directly injection-charged to its normal polarity, which is negative, through frictional charging with the developing blade 35 and by a potential difference established between the developing blade 35 and the developing roller 31.

The fixation apparatus 40 is thermal fixing unit that performs fixing processing by heating and melting the toner on the recording material. The fixation apparatus 40 includes a fixing film 42, a fixing heater 43 such as a ceramic heater for heating the fixing film 42, a thermistor 44 for measuring the temperature of the fixing heater 43, and a fixing roller 41 which is brought into pressure contact with the fixing film 42.

It is noted that, in the present example, the process cartridge 20 detachably attached to the main body of the image forming apparatus is used. However, the present example is not limited thereto, and any configuration may be used as long as a prescribed image forming process can be performed. For example, the portion of the process cartridge 20 corresponding to the developing apparatus 30 may be configured as a developing cartridge that is detachably attached to the image forming apparatus 100. Further, a drum cartridge having a drum unit detachably provided to the image forming apparatus 100 may be used. Also, a toner cartridge that supplies the developing apparatus 30 with the toner from the outside may be used. Also, a configuration using no cartridge may be used.

### 2. Control Configuration

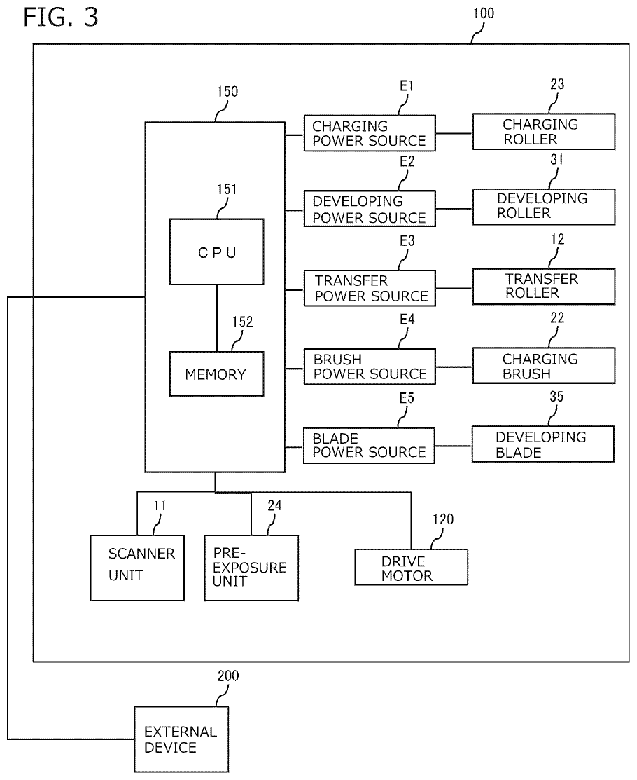

FIG. 3 is a schematic block diagram showing a control configuration of a main portion of the image forming apparatus 100 according to the present example. The image forming apparatus 100 is provided with a control unit 150. The control unit 150 includes a CPU 151, which is a central unit that serves as arithmetic control unit for performing arithmetic processing, memory 152 (storage elements) such as a ROM (Read Only Memory) and a RAM (Random Access Memory) serving as storage unit, and an input/output unit (not shown) for controlling the transmission and reception of signals between various components connected to the control unit 150. The RAM stores the detection results from sensors and the calculation results, and the ROM stores control programs, data tables obtained in advance, and the like.

The control unit 150 is control unit that comprehensively controls operations of the image forming apparatus 100. The control unit 150 executes a predetermined image forming sequence by controlling the timing of transmission and reception of various electrical information signals and the timing of driving operations. Various parts of the image forming apparatus 100 are connected to the control unit 150. The control unit 150 controls the charging power source E1, the developing power source E2, the transfer power source E3, the brush power source E4, and the blade power source E5. The charging power source E1 applies a charging voltage to the charging roller 23. The developing power source E2 applies a developing voltage to the developing roller 31. The transfer power source E3 applies a transfer voltage to the transfer roller 12. The brush power source E4 applies a brush voltage to the charging brush 22. The blade power source E5 applies a blade voltage to the developing blade 35.

### 3. Image Forming Operation

The image forming apparatus 100 processes image information input from an external device 200 to the image forming apparatus 100 to generate time-series digital pixel signals and transmits the time-series digital pixel signals to the control unit 150. The scanner unit 11 outputs a laser beam L modulated in response to the digital pixel signal to scan and expose the charged surface of the photosensitive drum 21. In this way, an electrostatic latent image is formed on the surface of the photosensitive drum 21. At the time, the photosensitive drum 21 is previously charged by the charging brush 22 and the charging roller 23. Thereafter, the electrostatic latent image is developed by the toner supplied from the developing roller 31, and a toner image is formed on the photosensitive drum 21.

The recording material P is stored in a recording material cassette 7 as a recording material storage unit and is fed out one by one by a feed roller 8 as a feed member. Thereafter, the recording material P is transported by a transport roller 9 as a transport member and is supplied to a transfer nip Nt along a pre-transfer transport guide 15 as a guide member. The transport roller 9 supplies the recording material P to the transfer nip Nt in such a manner that the transport roller 9 is in timing with the toner image on the photosensitive drum 21 based on the detection result of the leading end of the recording material P in the conveying direction by the top sensor 10 as the recording material detecting unit.

At the transfer nip Nt, the toner image borne on the photosensitive drum 21 is transferred onto the recording material P by the transfer roller 12, to which a transfer voltage is applied from the transfer power source E3. After the transfer, the photosensitive drum 21 is uniformly exposed to light in the longitudinal direction by the pre-exposure unit 24 (position Pf), thereby equalizing its surface potential.

The discharging needle 19 removes excess electric charge from the surface of the recording material P, onto which the toner image has been transferred at the transfer nip Nt. The recording material P that has passed the discharging needle 19 is transported to the fixation apparatus 40 along a transfer-fixing transport guide 118 which serves as a guide member. The fixation apparatus 40 applies heat and pressure to the recording material P as it passes through the nip between the fixing roller 41 and the fixing film 42, thereby fixing the toner image onto the recording material P. Thereafter, the recording material P is discharged onto a discharge tray 14 formed on the top surface of the image forming apparatus 100 by the discharge roller 13.

### 4. Recovery of Untransferred Residual Toner

In this example, a so-called cleaner-less configuration is adopted, in which residual toner on the photosensitive drum 21 without being transferred to the recording material P is recovered and reused in the developing apparatus 30. The untransferred residual toner is reused in the following steps. The untransferred residual toner includes toner that is charged with the opposite polarity to the normal polarity in this example (which is negative polarity) and the toner that is charged with negative polarity but does not have sufficient charge. A charging voltage greater toward negative polarity than that of the surface of the photosensitive drum 21 is applied to the charging brush 22, which assists in charging the surface of the photosensitive drum 21. This assisted charging by the charging brush 22 injects a negative charge into the untransferred residual toner that is charged positively and into the toner that does not have sufficient negative charge. As a result, the untransferred residual toner that has sufficient negative charge does not adhere to the charging brush 22 or the charging roller 23 and is transported along with the rotation of the photosensitive drum 21. As a result, the charging roller 23 can maintain good charging performance.

The untransferred residual toner that has adhered to the surface of the photosensitive drum 21 that has passed through the contact point (Pa) with the charging brush 22 and the contact point (Pb) with the charging roller 23 reaches the developing portion Pd as the photosensitive drum 21 rotates.

The behavior of the untransferred residual toner that has reached the developing portion Pd will be described, separately about the exposed portion and the non-exposed portion of the photosensitive drum 21. In the non-exposed portion of the photosensitive drum 21, i.e., the dark potential portion VD, the surface potential of the photosensitive drum 21 is greater than the developing voltage applied to the developing roller 31 on the negative polarity side. Therefore, the untransferred residual toner, which has sufficient negative polarity charge, moves towards the developing roller 31 due to the Coulomb force of the electric field and is recovered in the developing container 32. As described above, the dark potential portion VD of the photosensitive drum 21 is described as a non-exposed portion. However, if the surface potential is more negative than the developing voltage applied to the developing roller 31, the portion can be considered as a dark potential portion VD. Accordingly, not only non-exposed portions but also weakly exposed portions may be regarded as dark potential portions VD.

Toner recovered in the developing container 32 is mixed and dispersed with the toner inside the developing container 32 by the stirring member 34 and is again used in the development steps as it is borne on the developing roller 31.

Meanwhile, the exposed potential VL of the photosensitive drum 21, or the surface potential of the photosensitive drum 21 is less negative than the developing voltage applied to the developing roller 31. As a result, the untransferred residual toner is not transferred from the photosensitive drum 21 to the developing roller 31 at the developing portion Pd and remains on the surface of the photosensitive drum 21. The untransferred residual toner remaining on the surface of the photosensitive drum 21 is carried, along with other toner transferred from the developing roller 31 to the exposed portion Pc, on the photosensitive drum 21 toward the transfer portion Pe (transfer nip Nt), where it is transferred onto the recording material P.

In the present example, VD is set to −500 V, and VL is set to −50 V. As described above, since the developing voltage is −300 V, the back contrast, which is defined as the potential difference between the dark potential VD of the photosensitive drum 21, which has passed through the second charging position Pb with the charging roller 23 and the developing voltage (i.e., the surface potential of the developing roller 31), is Δ200 V. The back contrast, which is defined as the potential difference between the exposed potential VL of the photosensitive drum 21 and the developing voltage (the surface potential of the development roller 31), is Δ250 V

### 5. Charging Configuration

The charging of the photosensitive drum 21 by the charging brush 22 and the charging roller 23 in the present example will be described in detail.

The charging brush 22 charges the photosensitive drum 21 mainly by direct injection charging. The direct injection charge does not generate discharge products because the charging does not involve discharge. However, since only the areas in direct contact with the photosensitive drum 21 can be charged, uneven charging occurs if the charging brush 22 does not make uniform contact with the photosensitive drum 21. The influence of the discharge product will be described later.

The charging roller 23 charges the photosensitive drum 21 mainly by discharge. Since the discharge occurs at a non-contact position according to Paschen's law, a place where the charging roller 23 and the photosensitive drum 21 are not in contact with each other can also be charged. Therefore, the charging roller 23 can uniformly charge the photosensitive drum 21.

As in this example, by providing the charging brush 22 on the upstream side in the rotational direction of the photosensitive drum 21 and the charging roller 23 on the downstream side, generation of discharge products is suppressed by the direct injection charging by the charging brush 22 on the upstream side, and the surface of the photosensitive drum 21 can be uniformly charged by the discharging by the charging roller 23 on the downstream side. The charging brush 22 and the charging roller 23 will be described in detail below.

### 5.1 Charging Roller

The charging roller 23 of the present example is a multilayer roller having a core metal having a diameter of 6 mm and made of stainless steel as a support, and the core is covered with a plurality of flexible resin layers. In the present example, the roller has a two-layer structure including a base layer, which is a first resin layer that covers the core metal, and a surface layer, which is a second resin layer which covers the base layer. The resin material of the base layer is conductive hydrin rubber having conductive carbon dispersed therein, and is formed on the core metal by extrusion molding, with a film thickness of approximately 2 mm. Note that any resin material that is both flexible and conductive may be used and the resin material of the base layer is not limited to conductive hydrin rubber.

In the present example, a high-resistance resin layer having a film thickness of about 30 μm and an appropriate surface roughness Ra is spray-coated as a surface layer on the base layer of the charging roller 23. By making the outermost surface highly resistive, it is possible to suppress charge transfer from the charging roller 23 to the photosensitive drum 21. Furthermore, by providing the appropriate surface roughness Ra, the charging roller 23 and the photosensitive drum 21 come into point contact with each other, so that the area through which charges are injected can be reduced. In this configuration, the coating liquid for the surface layer is prepared by mixing, at a weight ratio of about 50%, roughening particles having a particle diameter of about 20 μm and made of a urethane-based material, into a urethane-based resin material in order to impart the appropriate surface roughness Ra. The surface layer is then formed by spray-coating the coating liquid onto the base layer. The volume resistivity of the surface layer is about 1×10⁵ Ω·cm, and its surface roughness Ra is about 2.0 μm.

The volume resistivity of the surface layer of the charging roller 23 is preferably at least 1.0×10⁴ Ω·cm and not more than 1.0×10⁷ Ω·cm, and the surface roughness Ra is preferably in the range of 0.5 to 3.0 μm. If the volume resistivity of the charging roller 23 is too low, there is a possibility of leakage to the photosensitive drum 21 due to overcurrent. If the volume resistivity is too high, the voltage is less likely to be applied to the surface of the charging roller 23, and the discharge for uniform charging becomes unstable. Therefore, the above range of volume resistivity is preferred. Also, the above range is preferable for the surface roughness Ra because the uniform electrostatic property is liable to be stable.

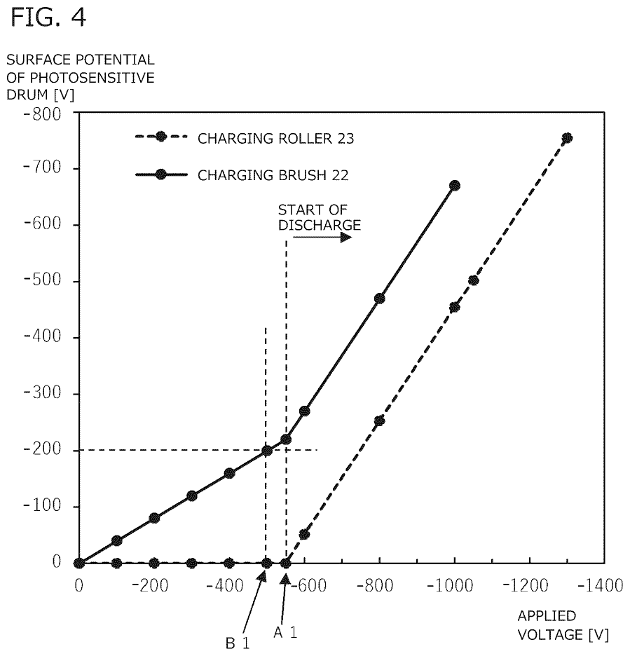

The charging characteristics of the charging roller 23 (indicated by the broken-line graph) under environmental conditions of a temperature of 32.5° C. and a humidity of 80% are shown in FIG. 4. In FIG. 4, the abscissa represents the voltage applied to the charging roller 23, and the ordinate represents the surface potential of the photosensitive drum 21. When examining the charging roller 23 as represented by the broken-line graph, it can be seen that in the present example, when the potential difference from the photosensitive drum 21 is equal to or less than −550 V, which is the discharge start voltage, the amount of charge is 0 V, and almost no direct injection charging occurs (reference sign A1).

A desired charging voltage is applied to the charging roller 23 by a second charging power source (charging power source E1) different from a first charging power source (brush power source E4) for applying a voltage to the charging brush 22, and the surface of the photosensitive drum 21 is uniformly charged to a negative target potential mainly by discharge. In this configuration, a charging voltage of −1050 V is applied to the charging roller 23, and the surface of the photosensitive drum 21 is uniformly charged to −500 V which is a target VD value.

### 5.2 Charging Brush

The resistance value of the charging brush 22 (volume resistivity of the charging brush 22) is measured by pressing a stainless sheet metal from above in the vertical direction of the charging brush 22 so that the amount of penetration is 1 mm and applying a voltage between the stainless steel plate and a base metal plate 22d. The voltage to be applied is +250 V, and the resistance value measured 5 seconds after the voltage application is defined as the brush resistance. A HIOKI model ST5520 was used for the resistance measurement.

In the present example, the brush resistance is at least 1.0×10⁴Ω and not more than 1.0×10⁶Ω. The brush resistance can be controlled to a desired value by adjusting the material and content of the conductive particles dispersed in the conductive pile yarn.

If the brush resistance is too high, current flow becomes insufficient, which makes it difficult to appropriately charge the surface of the photosensitive drum. Meanwhile, if the brush resistance is too low, a large local current may flow from the charging brush 22 to the photosensitive drum 21, which can cause dielectric breakdown in the photosensitive layer of the photosensitive drum 21, increasing the likelihood of so-called pinhole leakage. In view of the foregoing, the brush resistance is desirably at least 1.0×10²Ω and not more than 1.0×10⁸Ω.

The charging brush 22 of the present example is formed by fixing a 5 mm wide fabric having a pile structure made of conductive nylon fibers onto a stainless steel plate, which also serves as a power supply electrode. The conductive nylon fibers have a fineness of 2 denier, a flocking density of 200 kF/inch², and a pile length of 4 mm, and the brush is brought into contact with the photosensitive drum 21 such that the tip of the pile penetrates the drum surface by 0.6 mm. Here, the unit kF/inch² for flocking density represents the number of filaments per square inch. The charging brush 22 is arranged such that the tips of the brush fibers are in substantially uniform contact with the photosensitive drum 21, so that variation in the fiber tips attributable to rotation of the photosensitive drum 21 is reduced.

If the contact pressure of the charging brush 22 is too high, scratches or other defects may occur on the photosensitive drum 21 due to the charging brush 22. In the present example, a cleaner-less configuration is adopted, in which no cleaning member is provided to remove the developer remaining on the surface of the photosensitive drum 21. In such a cleaner-less configuration, if the contact pressure between the charging brush 22 and the photosensitive drum 21 is too high, untransferred residual toner left on the photosensitive drum 21 may be blocked by the charging brush 22, leading to contamination of the charging brush 22 and a reduction in charging performance. Meanwhile, if the contact pressure of the charging brush 22 is too low, the brush 22 may fail to make uniform contact or may tilt or shift due to the rotation of the photosensitive drum 21. In view of the foregoing, the contact pressure is desirably in the range of 40 gf to 200 gf.

Referring again to FIG. 4, the charging characteristics of the charging brush 22 under environmental conditions of a temperature of 32.5° C. and a humidity of 80% are examined (solid-line graph). In the charging brush 22 of the present example, it can be seen that a potential is gradually formed when the applied voltage is equal to or less than −550 V, indicating that the potential is formed without discharge caused by injection charging.

When a charging voltage of −500 V is applied to the charging brush 22, the surface potential VD of the photosensitive drum 21 increases to −200 V due to injection charging (reference sign B1). The current flowing through the charging brush 22 at this time is 17 μA, which is a relatively large current compared to that flowing through the charging roller 23.

In the present example, the charging brush 22 is affixed to a flexible sheet and brought into contact with the photosensitive drum 21 under a prescribed pressure, but the configuration is not limited thereto. For example, the charging brush 22 may be configured such that both ends of a support for the charging brush 22 are pressed against the photosensitive drum 21 using springs or the like. Alternatively, the charging brush 22 may be fixed to a cartridge frame and brought into contact with the photosensitive drum 21 at a prescribed penetration depth.

### 6. Photosensitive Drum 21

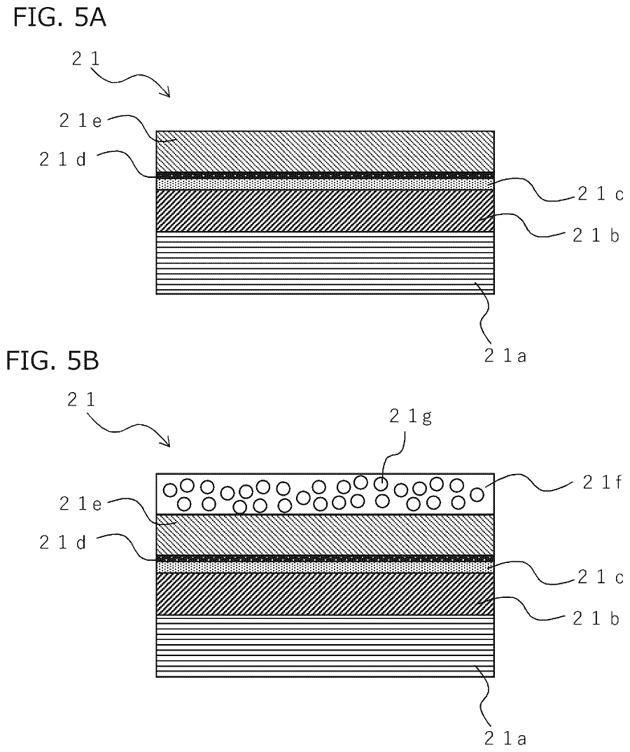

The photosensitive drum 21 of this embodiment is obtained by providing a photosensitive material such as an organic photoconductor (OPC), amorphous selenium, or amorphous silicon on a cylindrical drum substrate made of aluminum or nickel. The photosensitive drum 21 used in this example is a negatively charged OPC having an outer diameter of q 24 mm. As shown in FIG. 5A, the photosensitive drum 21 has a support 21a made of an aluminum cylinder, a conductive layer 21b, an underlying layer 21c, and a photosensitive layer having a two-layer structure including a charge generating layer 21d and a charge transport layer 21e. For each layer, materials similar to those used in the conventional devices can be utilized, and for example, materials listed in Japanese Patent Laid-Open No. 2023-056470 can be used.

An additional layer may be coated on the charge transport layer 21e for the purpose of suppressing abrasion of the drum surface and adjusting the coefficient of friction.

The volume resistivity of the surface of the photosensitive drum 21 in Example 1 is 1.0×10¹⁵ Ω·cm. Note that the volume resistivity is typically from 1.0×10⁹ to 1.0×10¹⁵ Ω·cm. From the viewpoint of further improving the performance of the injection charging, the range is preferably from 1.0×10¹² to 1.0×10¹³ Ω·cm.

An example of a method for measuring the volume resistivity of the surface of the photosensitive drum 21 will be described. A pA (picoampere) meter can be used to measure the volume resistivity. First, comb-shaped gold electrodes having an inter-electrode distance (D) of 180 μm and a length (L) of 59 mm are formed on a PET film by vapor deposition. Then, a charge injection layer having a thickness (T1) of 2 μm is provided thereon. The volume resistivity ρv (Ω·cm) was obtained by measuring the direct current (DC) current (I) flowing when a DC voltage of 100 V was applied between comb-shaped electrodes under environmental conditions of a temperature of 23° C./a humidity of 50% RH and a temperature of 32.5° C./a humidity of 80% RH, in accordance with the following Equation (1).

$$Volume resistivity ρ v ( Ω \cdot cm ) = V ( V ) \times T 1 ( cm ) \times L ( cm ) / I ( A ) \times D ( cm ) \} \qquad ( 1 )$$

When it is difficult to identify the composition of the charge injection layer, such as the conductive particles or binder resin, the surface resistivity of the surface of the photosensitive drum is measured and converted into volume resistivity. When measuring the volume resistivity of the charge injection layer in a state where it is coated on the surface of the photosensitive member rather than as a standalone material, it is preferable to measure the surface resistivity of the charge injection layer and convert the result into volume resistivity.

In this embodiment, comb-shaped electrodes having an inter-electrode distance (D) of 180 me and a length (L) of 59 mm is formed by gold deposition on the surface of the charge injection layer of the photosensitive drum. Then a DC voltage (I) when a DC voltage (V) of 1000 V was applied between the comb-shaped electrodes under environment conditions of a temperature of 23° C./a humidity of 50% RH was measured, and the surface resistivity ps of the charge injection layer was calculated from the DC voltage (V)/DC voltage (I). Using the film thickness t (cm) of the charge injection layer, the volume resistivity ρv (Ω·cm) was calculated by the following Equation (2).

ρv=ρs×t (2)

(where ρv is the volume resistivity, ps is the surface resistivity, and t is the thickness of the charge injection layer)

In this measurement, since the current to be measured is minute, it is preferable to use an instrument capable of measuring minute currents as the resistance measuring device. For example, a picoammeter 4140B manufactured by Hewlett-Packard may be used. The comb-shaped electrodes to be used and the applied voltage are preferably selected according to the material and resistance value of the charge injection layer in order to achieve an appropriate signal-to-noise ratio.

### 7. Effects of Discharge Products on Photosensitive Drum

When the image forming operation is performed using the image forming apparatus 100 and discharge is performed during the operation, discharge products such as ozone and NOx are generated in a small amount and may adhere to the surface of the photosensitive drum 21. Here, it is known that the amount of generated discharge products depends on the magnitude of the amount of discharge. Although discharge products are scraped off by a member that comes into contact with the photosensitive drum 21, if the amount of discharge products adhering to the surface exceeds the amount removed, the discharge products gradually accumulate on the surface of the photosensitive drum 21 through repeated image forming operations. The discharge products adhering to the surface of the photosensitive drum 21 absorb moisture and lower the surface electrical resistance of the photosensitive drum 21.

In particular, when discharge products adhere to the photosensitive drum 21 under high-temperature and high-humidity conditions, the electrical resistance of the surface of the photosensitive drum 21 decreases, and current tends to flow through the areas where a large amount of discharge products are attached. As a result, an appropriate electrostatic latent image or surface potential may not be formed on the surface of the photosensitive drum 21, which may cause image blur, or a phenomenon known as “image smearing”.

### 8. Charging Voltage Application Timing

The timing of charging voltage application, which is a feature of this example, will be described. In the present example, the charging brush 22 forms the potential of the photosensitive drum 21 by injection charging at a first charging position Pa located downstream of the transfer portion Pe and upstream of the second charging position Pb in the rotational direction Rd of the photosensitive drum 21. Thereafter, the charging roller 23 performs discharge with respect to the surface of the photosensitive drum that has been reliably injection-charged, at a second charging position Pb located downstream of the first charging position Pa and upstream of a developing portion Pd in the rotational direction Rd of the photosensitive drum 21. This is intended to suppress image smearing and maintain charging uniformity, thereby enabling stable image formation.

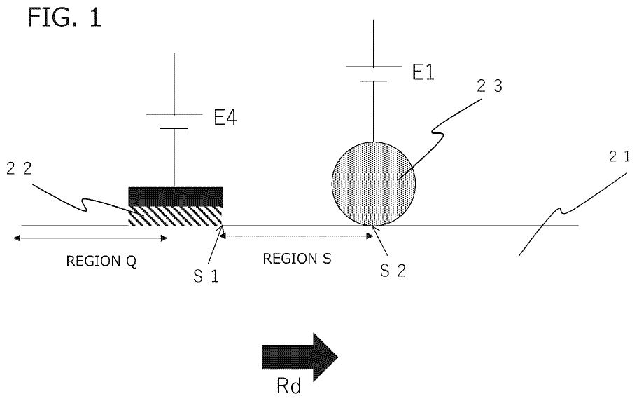

FIG. 1 is a schematic view of a region of a cross portion of the photosensitive drum 21 from the first charging position Pa to the second charging position Pb. Although the actual surface of the photosensitive drum 21 is curved as a part of the circumference, it is shown in a straight line in FIG. 1 for ease of understanding. Now, the uncharged region S (first region) between the charging brush 22 and the charging roller 23 will be described. For example, when the rotation of the photosensitive drum 21 stops and the voltage application to the charging brush 22 and the charging roller 23 stops after the image forming operation is completed, the surface potential gradually decreases over the entire surface of the photosensitive drum 21. When voltage application to the charging brush 22 and the charging roller 23 and the rotation of the photosensitive drum 21 are resumed in this state, a part of the uncharged region S is subjected to discharge by the charging roller 23 before the potential formation by the charging brush 22 is not sufficient. Stated differently, the uncharged region S immediately after the photosensitive drum 21 starts rotating, is already located downstream of the charging brush 22, and therefore passes through the charging roller 23 before injection charging by the charging brush 22 is performed. Accordingly, if a voltage has already been applied to the charging roller 23, the uncharged region S has its potential rapidly formed to a predetermined dark potential VD by discharge through the charging roller 23 before injection charging is carried out, resulting in a rapid potential formation. As a result, a large amount of discharge products is generated, increasing the risk of image smearing. Furthermore, if image formation is frequently performed in an intermittent manner, the uncharged region S, which appears each time the rotation starts, is subjected to strong discharge repeatedly, further increasing the risk of image smearing.

### 9. Advantageous Effects of Examples

The advantageous effects of the examples will be described with reference to Comparative Examples 1 to 3, using Table 1. Table 1 shows the configurations used in the experiment, the timing of voltage application to the charging brush 22 and the charging roller 23, and the durability evaluation results in Examples 1 to 4 and Comparative Examples 1 to 3.

TABLE 1

| | | | | Δ | | | | | | |
|---|---|---|---|---|---|---|---|---|---|---|
| | | | | potential | Elapsed time | | | | | |
| | | Applied voltage | | [V] | [ms] | | Δ time | | | |
| | Volume | [V] | | Potential | Charging | Charging | difference | Image quality evaluation | | |
| | resistivity | Charging | Charging | increase | 1 · t1 | 2 · t2 | [ms] | Image | Charging | Member |
| Example | (※1) | 1 (※2) | 2 (※3) | (※4) | (※5) | (※6) | t 2 − t 1 | smearing | unevenness | contamination |
| E1 | 1.E + 15 | −500 | −1050 | −300 | 50 | 110 | 60 | ◯ | ◯ | ◯ |
| E2 | 1.E + 12 | −500 | −1050 | −100 | 50 | 110 | 60 | ⊚ | ◯ | ◯ |
| E3 | 1.E + 12 | −500 | −1050 | −100 | 50 | 400 | 350 | ⊚ | ◯ | ◯ |
| E4 | 1.E + 12 | −500 | −1050 | −100 | 50 | (※7) | 0 | ⊚ | ⊚ | ⊚ |
| CE1 | 1.E + 15 | N/A | −1050 | −500 | 50 | 50 | 0 | X | ◯ | — |
| CE2 | 1.E + 15 | −500 | N/A | — | 50 | 50 | 0 | — | (※8) | — |
| CE3 | 1.E + 15 | −500 | −1050 | −300 | 50 | 50 | 0 | Δ | ◯ | — |

In Table 1, the volume resistivity of (*1) is the volume resistivity of the surface of the photosensitive drum 21. The “charge 1” (*2) is voltage applied from the brush power source E4 to the charging brush 22 as a first charging member. The “charge 2” (*3) is the voltage applied from the charging power source E1 to the charging roller 23 which is a second charging member. The “potential increase amount” (*4) indicates the potential of the portion formed by the discharge using the charging roller 23 when forming a second drum surface potential VD2=−500 V. The “charge 1, t1” (*5) refers to the period from timing t0, which is the drive start timing to the time when first charging by the charging brush 22 is performed. The “charge 2, t2” (*6) refers to the period from timing t0, which is the drive start timing to the time when second charging is performed by the charging roller 23. Note that, as will be described about Example 4, the timing of the second charging shown by (*7) is divided into two stages. The time difference between t1 and t2 is defined as Δ time difference. In “Example”, “E1” to “E4” means “Example 1” to “Example 4” and “CE1” to “CE3” means “Comparative Example 1” to “Comparative Example 3”. “N/A” means “No application”.

The durability evaluation method is as follows.
Test environment conditions: Temperature: 32.5° C., humidity: 80%
Cartridge life: 5000 sheets
Image Evaluation After feeding 3000 sheets under intermittent operation (2 sheets every 2 seconds), the apparatus was left to stand for one day, and then evaluation was conducted using a halftone image to check for “image smearing” and for “uneven charging” and “component contamination”, which are related to image uniformity. The state of formation of the drum potential at the time of drive start is checked before starting the durability test.
The uncharged region S between the charging brush 22 and the charging roller 23 was set to a distance of 10 mm. The peripheral speed of the drum was 170 mm/s.

The image quality evaluation is based on the presence or absence, and the degree, of image smearing, uneven charging, and component contamination.

The evaluation was conducted using four levels: ⊚ (no occurrence), ○ (almost no occurrence or only minor occurrence with no practical impact), Δ (slight occurrence), and × (clear occurrence). However, the number of evaluation levels is not limited to these. The evaluation may be performed by visual inspection by the tester, or by capturing the formed image and performing image recognition. It should be noted that, as will be described later with respect to Comparative Example 2, uneven charging indicated in (*8) could not be evaluated due to an initial defect.

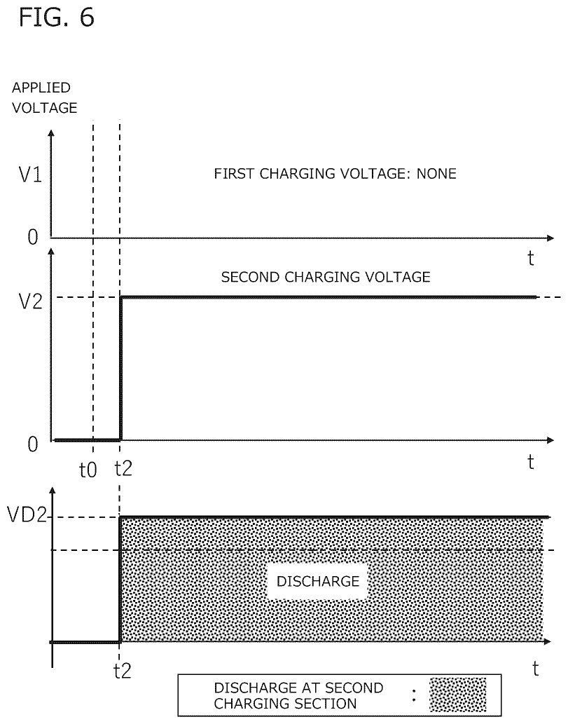

FIGS. 6 to 12 are timing charts for illustrating the Comparative Examples and examples. In each figure, in the upper graph, the abscissa represents the elapsed time t, and the ordinate represents the applied voltage. In the lower graph, the abscissa indicates the elapsed time t, and the vertical axis indicates the discharge amount of the second charging.

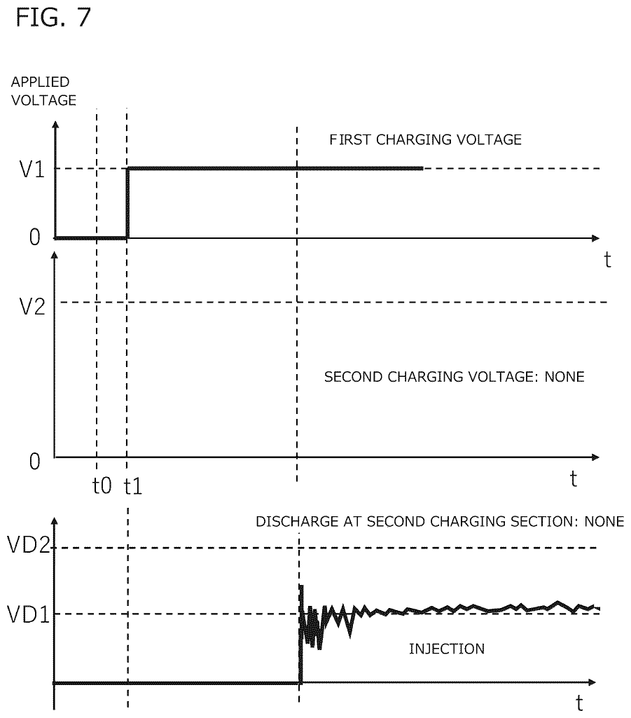

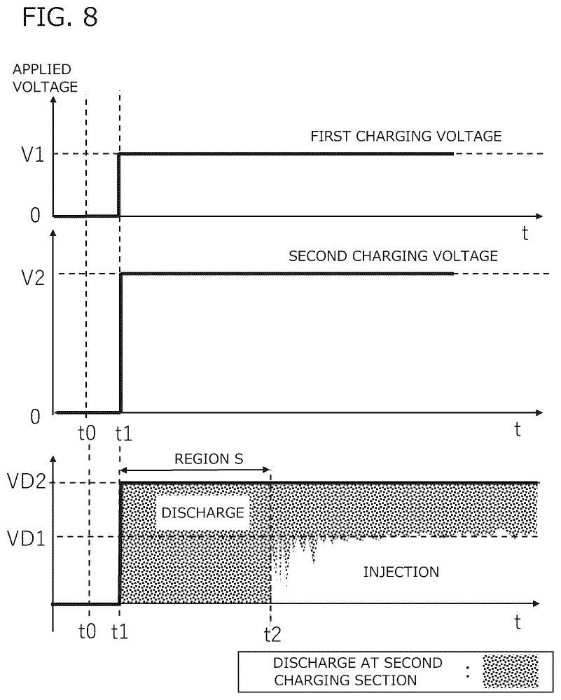

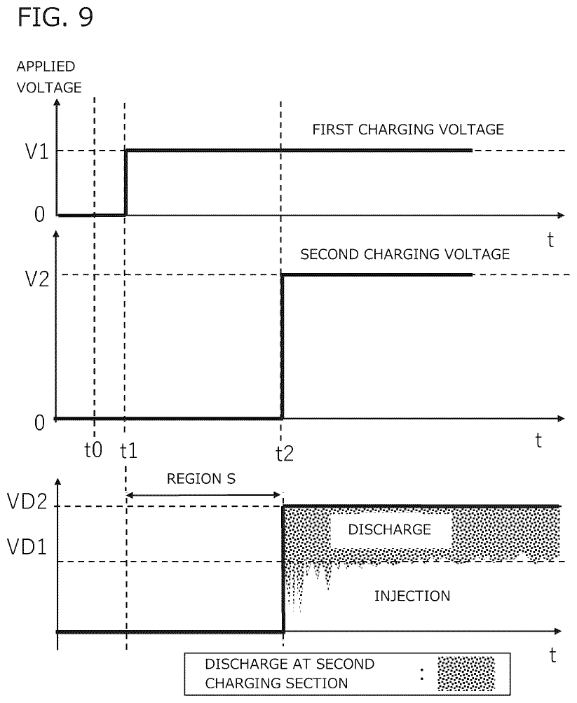

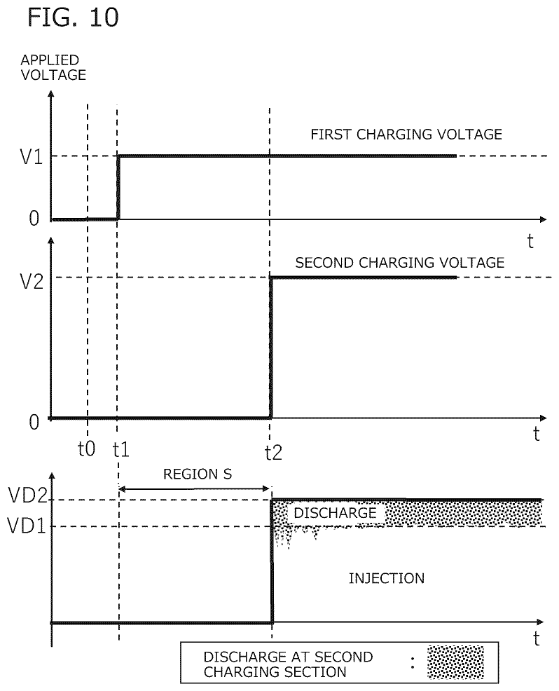

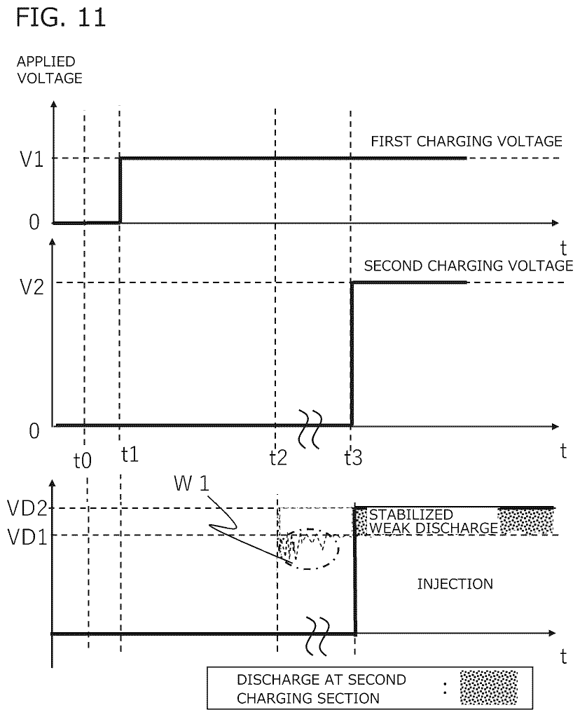

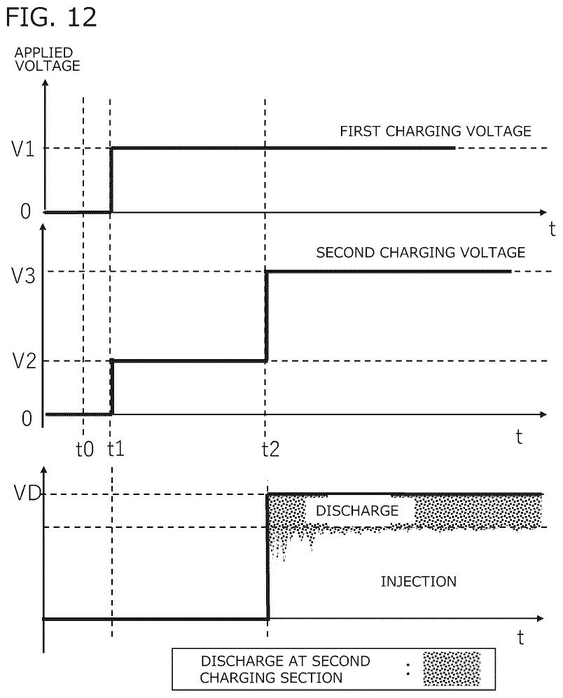

FIG. 6 shows the charge application timing and the discharge amount of the second charge in Comparative Example 1. FIG. 7 shows the charge application timing and the discharge amount of the second charge in Comparative Example 2. FIG. 8 shows the charge application timing and the discharge amount of the second charge in Comparative Example 3. FIG. 9 shows the charge application timing and the discharge amount of the second charge in Ex 1. FIG. 10 shows the charge application timing and the discharge amount of the second charge in Example 2. FIG. 11 shows the charge application timing and the discharge amount of the second charge in Example 3. FIG. 12 shows the charge application timing and the discharge amount of the second charge in Example 4. In FIGS. 6 to 12, the upper graph is related to change over time in the first charging voltage and the middle graph is related to change over time in the second charging voltage, and the lower graph is related to change over time in potential changes in the second charging part, including those due to injection and discharge. The abscissa (time t, including the timings t0, t1, and t2) is consistent across the upper, middle, and lower graphs.

In the figures, the first charging voltage V1 is a voltage applied to the charging brush 22 (first charging member). The second charging voltage V2 is a voltage applied to the charging roller 23 (second charging member). The first drum surface potential VD1 is a photosensitive drum surface potential formed by the charging brush 22. The second drum surface potential VD2 is a photosensitive drum potential formed as a result of charging by the charging roller 23 after the charging by the charging brush 22. In order to form an image, the second drum surface potential VD2 must be formed.

In the abscissa, the drive start timing is denoted as t0, the first charging voltage application timing as t1, and the second charging voltage application timing as t2. The Δ time difference represents the interval from the application of the first charging voltage V1 to the application of the second charging voltage V2 and is expressed as t2−t1 (ms).

### Comparative Example 1

Comparative Example 1 shown in FIG. 6 illustrates the potential formation on the photosensitive drum 21 in the case where voltage is applied only to the charging roller 23. The potential of the photosensitive drum is measured using a surface electrometer (not shown) disposed downstream of the charging roller 23.

In Comparative Example 1, since no voltage is applied to the charging brush 22, the drum potential is formed only by the second charging voltage V2=−1,050 V applied to the charging roller 23 at timing t2. Accordingly, all discharges are used to form a second drum surface potential VD2=−500 V (the potential formed by the discharge is indicated by the lower-stage shaded portion).

In Comparative Example 1, the occurrence of image smearing is included in the post-durable image quality evaluation. This is due to the generation of discharge products because all the potential formation of the charge is performed in the discharge.

### Comparative Example 2

Comparative Example 2 shown in FIG. 7 illustrates the potential formation on the photosensitive drum 21 when a voltage is applied only to the charging brush 22. In Comparative Example 2, since no voltage is applied to the charging roller 23, the voltage is applied only through injection charging by the charging brush 22. The charging voltage was set to a first charging voltage V1=−500 V before charging (0 V in this study). Since this voltage is equal to or less than a discharge start voltage (−550 V), the potential is formed by injection charging without causing discharge. However, as shown by the solid line graph in FIG. 4, the surface potential remains at approximately a first drum surface potential VD1=−200 V and a potential sufficient for stable image formation was not formed. In addition, uneven contact conditions of the brush fibers and the influence of untransferred residual toner adhering to the brush caused unevenness in the charging potential. For this reason, in Comparative Example 2, image defects occurred from the beginning (*8 in Table 1), and durability evaluation could not be conducted.

### Comparative Example 3

In Comparative Example 3 shown in FIG. 8, the charging brush 22 and the charging roller 23 simultaneously applied voltage at timing t1. That is, after 50 ms from the drive start timing t0, the first charging voltage V1=−500 V and the second charging voltage V2=−1050 V are simultaneously applied. In this case, the uncharged region S of the photosensitive drum 21 undergoes a rapid potential change from 0 V to VD2=−500 V without being subjected to injection charging by the charging brush 22. As a result, the greater amount of discharge occurs in the range corresponding to the uncharged region S in the shaded area in the lower graph in FIG. 8. Then, discharge is performed by the charging roller 23 in the region located downstream of the uncharged region S in the rotational direction (shown as the downstream region Q in FIG. 1). Since this discharge occurs on the surface of the photosensitive drum that has already been subjected to injection charging by the charging brush 22 (VD1=−200 V), the discharge amount is smaller than that for the uncharged region S. Furthermore, in the downstream region Q, potential unevenness due to injection charging is evened out by discharge, and a stabilized potential is obtained.

In the durability evaluation of Comparative Example 3, the occurrence of image smearing was suppressed more than in Comparative Example 1. However, since there were some areas with insufficient image density and it could not be concluded that there was no occurrence of image smearing, the evaluation was rated as “Δ”. Note that in Comparative Example 3, some areas of the half-tone images exhibited densities lower than normal. This is presumably because a large amount of discharge occurred in the region S at the initial stage of the print drive, making image smearing more likely.

### Example 1

In Example 1, in order to ensure that the injection charge is performed before discharge to the surface of the photosensitive drum by the charging roller 23, the timing of applying the voltage to the charging roller 23 is delayed relative to the timing of applying the voltage to the charging brush 22.

In Example 1 shown in FIG. 9, the application of the first charging voltage V1 by the charging brush 22 was performed at timing t1, which was 50 ms after the drive start timing t0. In this case, the first charging voltage V1 was set to −500 V. Then, at timing t2, which was 110 ms after the drive start timing t0, the application of the second charging voltage V2 (−1,050 V) by the charging roller 23 was performed. The A time difference at the time is t2−t1=60 ms. Accordingly, the voltage is applied to the charging roller 23 after the uncharged region S passes through the second charging portion. That is, it is ensured that the discharge is performed by the second charging portion only at locations that have already been subjected to injection charging by the first charging portion. Therefore, the discharge amount of the photosensitive drum 21 is Δ300 V (VD1=−200 V to VD2=−500 V), and stable potential formation is achieved.

In the durability evaluation, no image smearing occurred, and the evaluation was rated as “○”. The evaluation for charging unevenness was also rated as “○”. However, when durability testing was continued and paper feeding was performed up to 4000 sheets, although there were no practical problems, areas with slightly reduced density were observed. There were no problems related to member contamination.

In Example 1, the voltage was applied to the charging roller 23 at a timing when the entire uncharged region S had already passed the charging roller 23. That is, the upstream end S1 of the surface region of the photosensitive drum 21, which was located in the uncharged region S at timing t1, passed through the charging portion formed by the charging roller 23 as the photosensitive drum 21 rotated, and the voltage application by the charging roller 23 was started only after that. As a result, discharge was reliably performed only in the regions that had already undergone injection charging.

However, it is also possible to start applying voltage to the charging roller 23 before the entire uncharged region S has completely passed through the charging roller 23. That is, as long as the start timing of the discharge charging by the charging roller 23 is later than the start timing of the injection charging by the charging brush 22, a better result than Comparative Example 3 can be obtained.

### Example 2

In Example 2, a study was conducted using a configuration in which the surface of photosensitive drum 21 has a volume resistivity of 1.0×10¹² Ω·cm. The other configurations, including the timing of applying the charging bias, are the same as those in Example 1.

As shown in FIG. 5B, the photosensitive drum 21 used in Example 2 has a charge injection layer 21f provided on the charge transport layer 21e, for the purpose of reducing the resistivity of the surface of the drum to a prescribed value. As disclosed in Japanese Patent Laid-Open No. 2023-056470, the charge injection layer 21f typically contains an appropriate amount of conductive particles 21g to adjust the resistance value. In the present example, the volume resistivity of the charge injection layer 21f was adjusted to 1.0×10¹² Ω·cm.

An example of the configuration of the charge injection layer 21f and the conductive particles 21g will be described. Preferably, the volume resistivity of the charge injection layer 21f is adjusted to be at least 1.0×10⁹ Ω·cm and not more than 1.0×10¹⁴ Ω·cm. In the present example, as described above, it was set to 1.0×10¹² Ω·cm. In order to satisfy the range of the volume resistivity, the content of the conductive particles 21g is preferably at least 5.0 vol % and not more than 70.0 vol % relative to the total volume of the charge injection layer 21f. The volume resistivity of the charge injection layer 21f can be controlled by, for example, the particle size of the conductive particles 21g and also by the content of the conductive particles 21g. The particle size of the conductive particles 21g is preferably at least 5 nm and not more than 300 nm in terms of volume-based average particle diameter, and more preferably at least 40 nm and not more than 250 nm.

Examples of the conductive particles 21g contained in the charge injection layer 21f include particles of metal oxide such as titanium oxide, zinc oxide, tin oxide, and indium oxide. When a metal oxide is used as the conductive particles 21g, the metal oxide may be doped with an element such as niobium, phosphorus, aluminum, or its oxide. The conductive particles 21g may have a particle and a laminated structure covering the particle. The particles may include those of titanium oxide, barium sulfate, and zinc oxide. Examples of the coating material include metal oxide such as titanium oxide and tin oxide, and according to the present disclosure, titanium oxide is preferred from the standpoint of ease of charge injection from the charging brush 22.

The charge injection layer 21f may contain polymers or resins derived from compounds having polymerizable functional groups. Examples of such polymerizable functional groups include isocyanate groups, blocked isocyanate groups, methylol groups, alkylated methylol groups, epoxy groups, metal alkoxide groups, hydroxyl groups, amino groups, carboxyl groups, thiol groups, carboxylic acid anhydride groups, carbon-carbon double bond groups, alkoxysilyl groups, and silanol groups. As the compound has a polymerizable functional group, a monomer with charge transport properties may be used. Examples of resins include polyester resin, acrylic resin, phenoxy resin, polycarbonate resin, polystyrene resin, phenol resin, melamine resin, and epoxy resin. Among these, acrylic resin is preferred.

As can be seen from a comparison between the lower graph of FIG. 9 (Example 1) and that of FIG. 10 (Example 2), the value of the potential (VD1) formed by injection charging is higher in FIG. 10. This is because the presence of the charge injection layer 21f provided on the outermost surface of the photosensitive drum 21 enhances the injection charging performance. In Example 1, VD1 was −200 V, whereas in Example 2, it improved to −400 V. In the configuration of Example 2, since the injection charging performance is improved, the amount of discharge received from the charging roller 23 is Δ100 V, which is lower than that in Example 1. As a result, the discharge amount can be reduced.

In the durable testing result, there were no image smearing, charge unevenness, and the like. Although the durability testing was continued and paper feeding was performed up to 4000 sheets in the same manner as in Example 1, since the same results are obtained for 3000 sheets, the evaluation for the image smearing was rated as “⊚”. However, when the durability testing was continued and paper feeding was performed up to 5000 sheets, although there were no practical problems, areas with slightly reduced density were observed.

### Example 3

In Example 3, the voltage is applied to the charging roller 23 after the uncharged region S of the photosensitive drum 21 has passed it, as in in Examples 1 and 2. However, in Example 3, the second charging voltage was applied at timing t2 which was significantly later than in Examples 1 and 2 (t2=400 ms). As a result, the A time difference (t2−t1) was 350 ms, which is significantly longer.

Here, as indicated by the dashed line W1 in FIG. 11, immediately after the application of the voltage to the charging brush 22, there is a time when the potential of the photosensitive drum is unstable, and the potential of the charged potential may not be locally formed in some cases. It is considered that the slight change in potential appears as a result of the change in the contact point between the photosensitive drum 21 and the charging brush 22 due to the micro movement of the fibers of the brush due to the electric field between the photosensitive drum 21 and the charging brush 22 when the voltage is applied to the charging brush 22. It is experimentally known that this minute change is stable approximately 300 ms after the voltage application to the charging brush 22. Sufficient effects can be obtained by merely applying a voltage to the charging roller 23 after the uncharged region S of the photosensitive drum 21 passes through the charging roller 23, as in Examples 1 and 2. However, by setting the difference between t2−t1 to 300 ms or more as in this example, local discharge can be suppressed as much as possible and stable discharge can be achieved.

In the durable testing result, there were no image smearing, charge unevenness, and the like. The durability testing was continued, and paper feeding was performed up to 5000 sheets in the same manner as in Example 2, the evaluation of image smearing was rated as “⊚” since the same results were obtained for 3000 sheets. It can be seen that the present example is more effective for image smearing than in Example 3.

### Example 4

The feature of Example 4 is that the voltage applied to the charging roller 23 is increased stepwise from V2 to V3. When the timing of voltage application to the charging roller 23 is later than the timing of voltage application to the charging brush 22 as in Examples 1 to 3, the electric field between the uncharged region S of the photosensitive drum 21 and the charging roller 23 is not applied while the voltage is not applied to the charging roller 23. Alternatively, when there is a slight residual charge on the photosensitive drum 21, a force is exerted to transfer electrically positive (positively charged) deposits from the charging roller 23 to the photosensitive drum 21. Accordingly, when various positive foreign matter or toner particles adhere to the charging roller 23 during previous image formation, the deposits from the charging roller 23 move to the photosensitive drum 21 at the start of the photosensitive drum 21. Since the deposits are electrically positive, they are not collected by the developing roller 31 in an electric field and may contaminate the transfer roller 12 and the charging brush 22.

In Example 4, similarly to Comparative Example 3, the timing of applying the voltage to the charging brush 22 and the charging roller 23 is the same. However, as shown in FIG. 12, the second charging voltage V2 applied to the charging roller 23 at the initial application is set to be equal to or lower than the discharge start voltage. Specifically, a voltage of −500 V as V2 is applied to the charging roller 23 at timing t1 (50 ms after t0). Then, at timing t2 (110 ms after t0), the voltage V3 applied to the charging roller 23 is increased to −1050 V.

In the configuration of this example, the voltage applied to the charging roller 23 is changed in two stages as described above. As a result, from the start of the drive, an electric field can be generated that applies a force between the charging roller 23 and the photosensitive drum 21 in the same direction as that during image formation. Accordingly, even if various positively charged foreign substances or toner adhere to the charging roller 23 during image formation, unintended discharge of the deposits from the charging roller 23 during driving of the photosensitive drum 21 can be suppressed.

It is preferable that the timing at which the voltage applied to the charging roller 23 is increased so that the potential difference between the charging roller 23 and the surface of the photoreceptor drum is greater than or equal to the threshold value from less than the threshold value of the start of discharge is set after the uncharged region S has passed the second charging position Pb. Thus, the uncharged region S is always subjected to injection charge at the first charging position Pa and then to discharge charge at the second charging position Pb, the amount of discharge can be reduced.

In the durability evaluation, up to 5000 sheets were evaluated, and it was confirmed that the amount of discharge was suppressed as in example 3, and uniform electrostatic charge was also ensured. Further, it was confirmed that unintended discharge of deposits from the charging roller 23 was suppressed and there was no change in image quality evaluation, but the contamination of the charging member after the durability was less than in Examples 1 to 3.

### Example 5

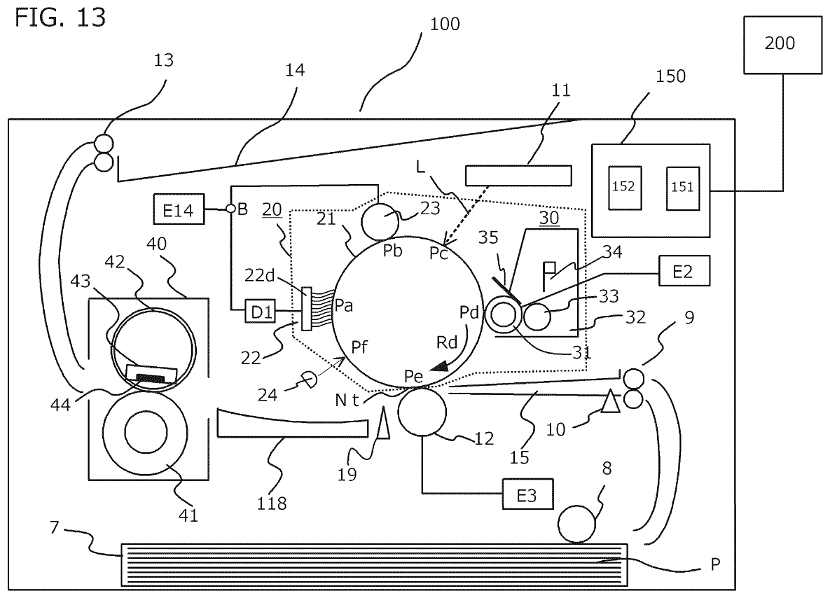

The present example is substantially the same as the configuration of Example 4, except for the following differences. As shown in FIG. 13, a common high-voltage power source E14 (common power supply) is provided in order to simplify the high-voltage configuration, which supplies voltage to both the charging power source E1 and the brush power source E4. The electric circuit for applying voltage from the common high-voltage power source E14 branches at a first branch point B and extends to the charging brush 22 and the charging roller 23. A Zener element D1 (−500 V) is provided between the branch point B and the charging brush 22. In other words, the electric circuit of the present example includes a common portion between the common high-voltage power source E14 and the first branch point B, a first portion between the first branch point B and the charging brush 22, and a second portion between the first branch point B and the charging roller 23.

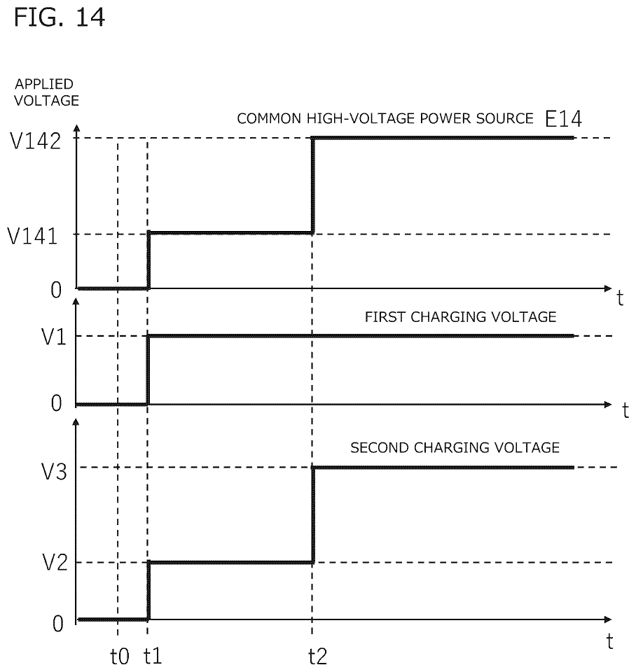

As shown in FIG. 14, at timing t1=50 ms, the common high-voltage power source E14 applies −500 V (V141). Then, at timing t2=110 ms, the voltage applied by the common high-voltage power source E14 is changed to −1050 V (V142). As a result, during the period from timing t1 to t2, both V1 and V2 are applied at −500 V, and after t2, V1=−500 V and V3=−1050 V are applied.

With this configuration, it is possible to reliably apply a voltage equal to or less than the discharge threshold to the charging brush 22, and a voltage exceeding the discharge threshold to the charging roller 23. In other words, even with variation in the timing of the high-voltage control, excessive discharge was suppressed, and the same performance as in Example 4 was obtained.

### Modification 1

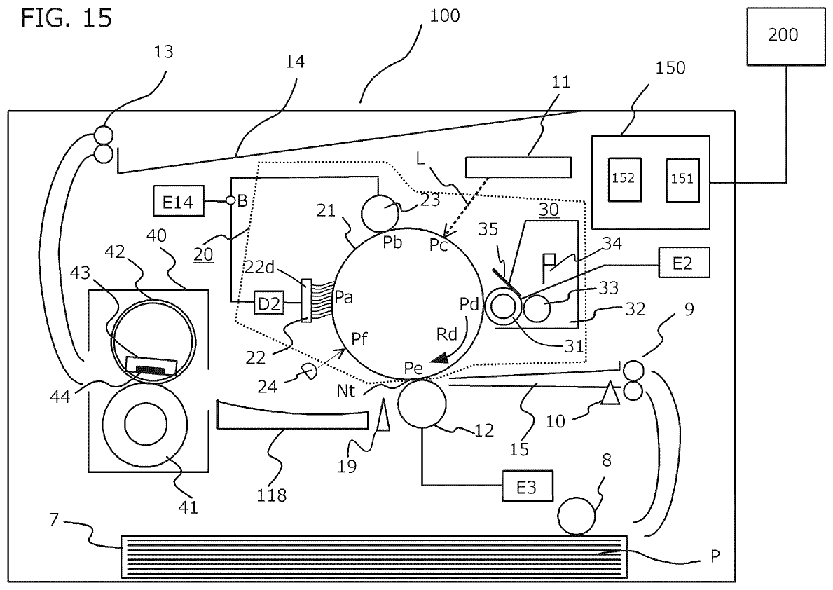

This modification is substantially the same as the configuration of Example 5, except for the following differences. In Example 5, the Zener element was provided in the high voltage circuit of the main body of the image forming apparatus, but in Modification 1, a Zener element D2 (−500 V) is arranged in the process cartridge 20 as shown in FIG. 15. The configuration of this modification can provide the same effects as in Example 5. Furthermore, the size (rated voltage) of the Zener element can be varied for each process cartridge 20 in accordance with the type of the photosensitive drum 21. For example, the Zener element can be selected in accordance with the surface resistance of the photosensitive drum 21, so that the applied voltage can be controlled to obtain a preferable surface potential.

### Example 6

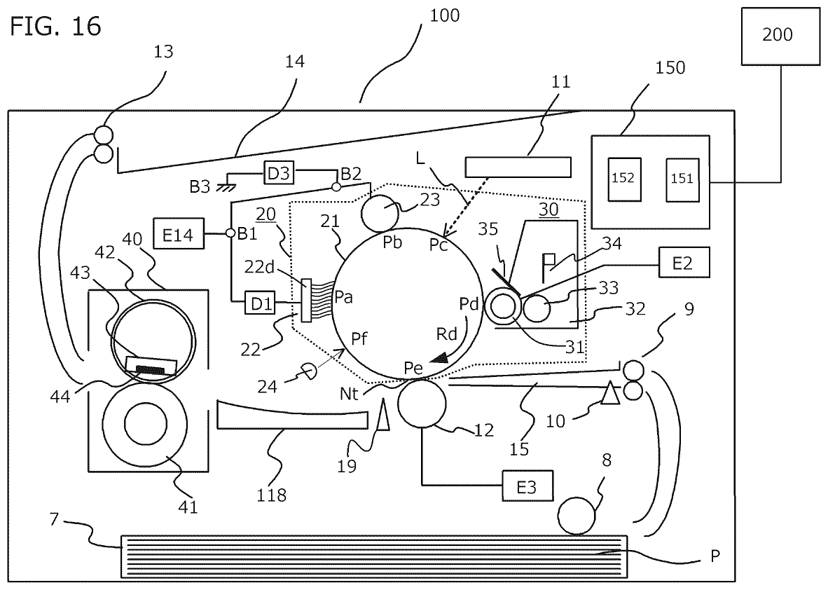

The present example is substantially the same as the configuration of Example 5, except for the following differences. As shown in FIG. 16, a Zener element D1 (−500 V) was arranged between the first branch point B1 and the charging brush 22. A second branch point B2 was provided between the first branch point B1 and the charging roller 23, and from the second branch point B2, a capacitor element D3 (0.2 μF) is connected to ground B3 via the capacitor.

In the present example, in consideration of stability and allowing effective current flow through the capacitor, B3 is grounded, but in order to allow more current to flow through the capacitor element D3, B3 may be connected to a prescribed potential, such as −600 V. A load resistance may also be provided between the branch points B1 and B2 to appropriately adjust the timing of voltage application to the second charging member.

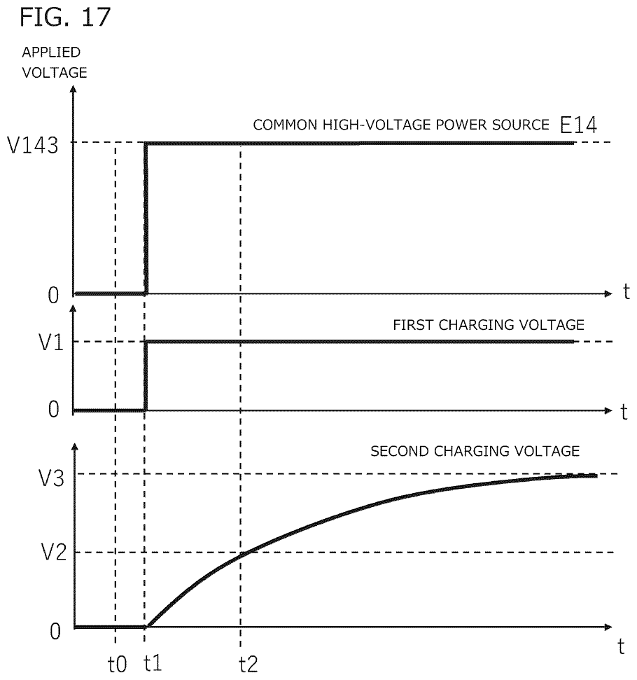

As shown in FIG. 17, in the control of the common high-voltage power source E14 of this example, −1050 V (V143) is applied when timing t1=50 ms. As a result, V1=−500 V is applied to the charging brush 22. Then, a capacitor element D3 connected to a branch point B1 and a branch point B2 between the charging roller suppresses a voltage applied to the charging roller 23 to equal to or less than a discharge threshold value during a period between the timing t1 and t2, a voltage exceeding a discharge threshold can be applied to the charging roller 23 after timing t2.

By using this example, it was possible to achieve performance the same as that of Example 4 while not only using a simplified circuit configuration but also simplifying the control operation of the common high-voltage power source E14.

### Modification 2

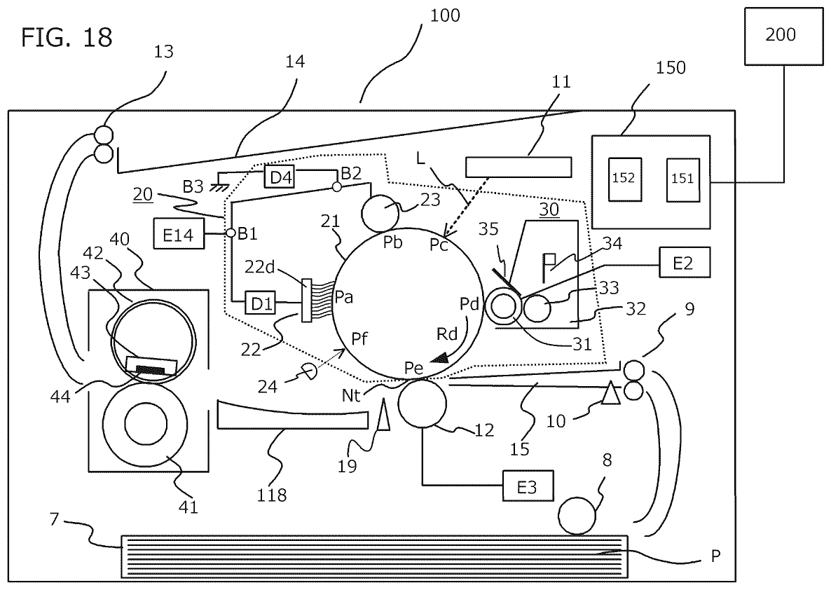

This modification is substantially the same as the configuration of Example 6, except for the following differences. In Example 6, a capacitor was used in the high-voltage circuit of the image forming apparatus main body. In contrast, as shown in FIG. 18, Modification 2 uses a capacitor element D4 (0.2 μF) provided in the process cartridge 20.

As a result, the capacitance of the capacitor element can be selected according to the type of photosensitive drum 21 or the type of charging roller 23. For example, even when the capacitance component of the drum surface differs, or the resistance of the charging roller 23 varies significantly, performance equivalent to that of Example 6 can still be achieved by adjusting the capacitance of the capacitor element.

### Example 7

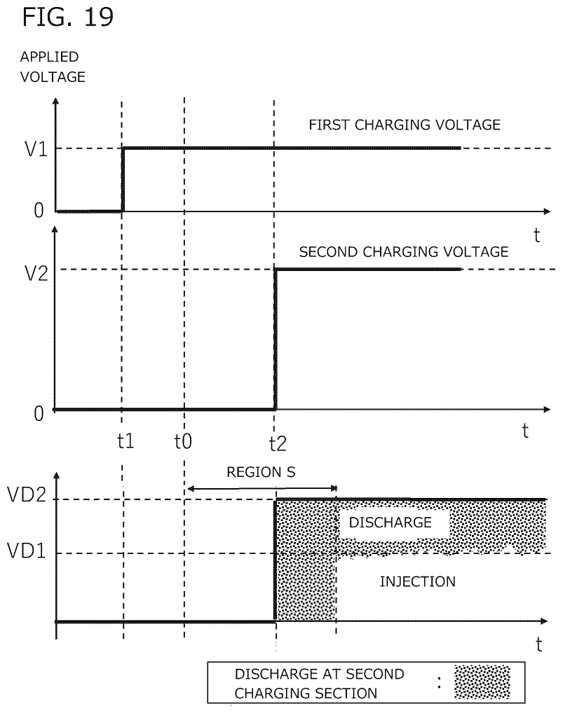

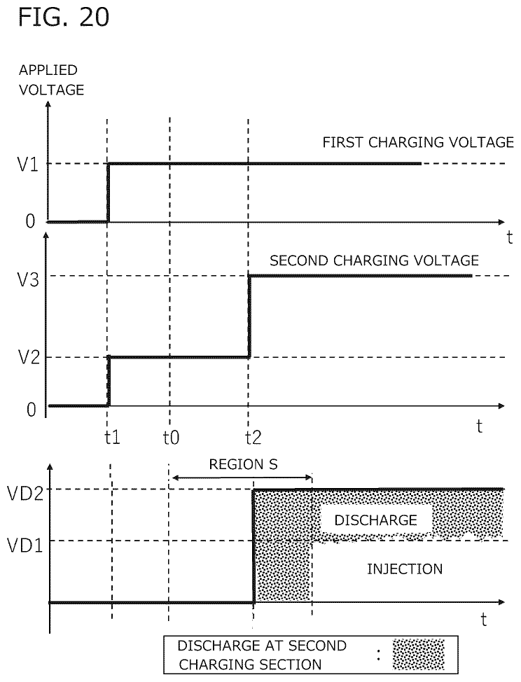

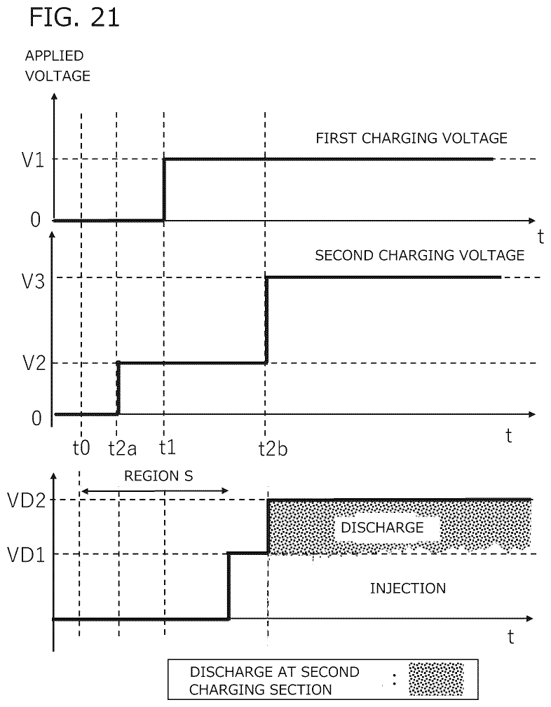

FIGS. 19 to 21 are timing charts for illustrating Examples 7 to 9. The meaning of the upper and lower graphs of each figure, as well as how to read the abscissa and ordinate, are the same as in FIG. 6. FIG. 19 illustrates the charge application timing and the discharge amount of the second charging in Example 7. FIG. 20 illustrates the charge application timing and the discharge amount of the second charging in Example 8. FIG. 21 shows the charge application timing and the discharge amount of the second charge in Example 9. In the description of these examples, for example the timing of starting the rotation of the photosensitive drum 21 are different from those in the previous examples.

In Example 7 shown in FIG. 19, the control unit 150 starts applying voltage to the charging brush 22 and starts charging by the charging brush 22 at the first charging position Pa (t1). Subsequently, the rotation of the photosensitive drum 21 is started (t0). After that, voltage application to the charging roller 23 is started, and charging by the charging roller 23 at the second charging position Pb is started (t2). In the present example, although the entire potential in part of the uncharged region S is formed by discharge, the generation of discharge products can be suppressed compared with Comparative Example 3.

That is, the timing of applying the first charging voltage may be before the photosensitive drum 21 starts rotating. The timing of applying the second charging voltage needs only be after a part of the region S on the surface of the photosensitive drum 21 has passed, and preferably after the entire region S has passed.

### Example 8

In Example 8 shown in FIG. 20, the control unit 150 starts applying voltage to both the charging brush 22 and the charging roller 23 at timing t1. At the time, the second charging voltage V2 applied to the charging roller 23 is set to be equal to or less than the discharge start voltage. Then, the rotation of the photosensitive drum 21 is started (t0), and then the voltage applied to the charging roller 23 is increased to a level equal to or higher than the discharge start voltage (t2). In this example, although all the entire potential in part of the uncharged region S is formed by discharge, the generation of discharge products can be suppressed compared with Comparative Example 3. Furthermore, by changing the voltage applied to the charging roller 23 in two stages, unintended discharge of adhered substances from the charging roller 23 can be suppressed even when various positively charged foreign substances or toner adhere to the charging roller 23 during image formation.

That is, the timing of applying the first and second charging voltages may be before the photosensitive drum 21 starts rotating. In such a case, the second charging voltage is preferably set to a voltage less than the discharge start voltage.

### Example 9

In Example 9 shown in FIG. 21, the control unit 150 starts rotating the photosensitive drum 21 at timing t0. Then, at timing t2a, voltage application to the charging roller 23 is started at a voltage equal to or less than the discharge start threshold. Then, at timing t1, voltage application to the charging brush 22 is started. Then, at timing t2b, the voltage applied to the charging roller 23 is increased. In this example, the generation of discharge products can be effectively suppressed. It should be noted that the main point of this example is that the advantageous effects of the present disclosure can still be obtained even when the first-stage voltage application to the charging roller 23 is started before the voltage application to the charging brush 22. Therefore, for example, the timing of starting the rotation of the photosensitive drum 21 may be between the timing t2a and the timing t1.

That is, the timing of applying the first charged voltage may be later than the timing of applying the second charged voltage. In this case, the second charging voltage is preferably a voltage less than the discharge start voltage, and the discharge start voltage is preferably applied after the region S formed starting from the timing when the first charging voltage is applied has passed through the second charging position Pb. As described above, in the configuration of each example, in the image forming apparatus 100 that performs charging at the first charging position Pa located upstream in the rotational direction of the photosensitive drum 21 and at the second charging position Pb located downstream, charging is started first at the upstream position and then at the downstream position. Alternatively, even when charging is started simultaneously on the upstream and downstream positions, or even when charging is started first at the downstream position, the voltage applied at the downstream position is initially set to a level at which no discharge occurs, and then later increased. With such a configuration, the discharge amount at the second charging position Pb can be stabilized regardless of the initial potential of the uncharged region S at the start of the drive of the photosensitive drum 21. As a result, adverse effects due to discharge, for example, the generation of discharge products and image defects caused by the deterioration of the photosensitive drum 21 can be suppressed.

The charging member provided at the upstream first charging position Pa is typically a charging device that performs injection charging using a charging brush 22, and the charging member provided at the downstream second charging position Pb is typically a charging device that performs contact charging using a charging roller 23. However, a brush roller or charging roller capable of injection charging may also be used as the charging member at the first charging position Pa. In addition, a charging device that performs wire corona discharge may be used as the charging member at the second charging position Pb.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-108035, filed Jul. 4, 2024, which is hereby incorporated by reference herein in its entirety.

What is claimed is:

1. An image forming apparatus comprising:
a photosensitive drum configured to be rotatable;
a first charging member configured to oppose the photosensitive drum to form a first charging portion, and to charge a surface of the photosensitive drum at the first charging portion in response to application of a first charging voltage thereto;
a developing roller configured to oppose the photosensitive drum to form a developing portion, and to supply a developer to the photosensitive drum at the developing portion;
a second charging member configured to oppose the photosensitive drum, in a position downstream of the first charging portion and upstream of the developing portion in a rotational direction of the photosensitive drum, to form a second charging portion, and to charge a surface of the photosensitive drum by discharge at the second charging portion in response to application of a second charging voltage of at least a discharge start threshold thereto; and
a control unit configured to control application of the first charging voltage to the first charging member and application of the second charging voltage to the second charging member, so that only a DC voltage is applied as the first charging voltage and the second charging voltage,
wherein
the control unit is configured to perform control such that the second charging voltage, which is equal to or greater than a threshold for start of discharge from the second charging member, is applied to the second charging member during rotation of the photosensitive drum and after application of the first charging voltage to the first charging member.

2. The image forming apparatus according to claim 1, wherein
the control unit is configured to perform control such that charging by discharge from the second charging member is performed on a portion of the surface of the photosensitive drum that has been charged by the first charging member.

3. The image forming apparatus according to claim 1, wherein
when a region of the surface of the photosensitive drum, which is located between the first charging portion and the second charging portion in the rotational direction at a start of charging by the first charging member, is defined as a first region, the control unit is configured to perform control such that charging by discharge from the second charging member is started after an upstream end of the first region has passed through the second charging portion by rotation.

4. The image forming apparatus according to claim 3, wherein
the control unit is configured to perform control such that the second charging voltage, which is less than the threshold for start of discharge, is applied to the second charging member during at least a part of a period from the start of charging by the first charging member at the upstream end of the first region until arrival of the upstream end at the second charging portion.

5. The image forming apparatus according to claim 1, wherein
the control unit is configured to perform control such that charging by discharge from the second charging member is started at least 300 ms after the start of charging by the first charging member.

6. The image forming apparatus according to claim 1, wherein
the control unit is configured to perform control such that rotation of the photosensitive drum is started after starting application of the first charging voltage to the first charging member.

7. The image forming apparatus according to claim 1, wherein
the control unit is configured to perform control such that rotation of the photosensitive drum is started after application of the first charging voltage to the first charging member and application of the second charging voltage, which is less than a threshold for start of discharge, to the second charging member.

8. The image forming apparatus according to claim 1, wherein
the surface of the photosensitive drum has a volume resistivity of 1.0×10⁹ to 1.0×10¹⁵ Ω·cm.

9. The image forming apparatus according to claim 8, wherein
the surface of the photosensitive drum has a volume resistivity of 1.0×10¹² to 1.0×10¹³ Ω·cm.

10. The image forming apparatuses according to claim 9, wherein
a charge injection layer containing conductive particles is provided on the surface of the photosensitive drum.

11. The image forming apparatus according to claim 1, wherein
the first charging member is a charging brush configured to perform injection charging.

12. The image forming apparatus according to claim 11, wherein
the first charging member has a volume resistivity of 1.0×10²Ω to not more than 1.0×10⁸Ω.

13. The image forming apparatus according to claim 1, wherein
the second charging member is a charging roller.

14. The image forming apparatus according to claim 13, wherein
the surface of the second charging member has a volume resistivity of 1.0×10⁴Ω to not more than 1.0×10⁷Ω.

15. The image forming apparatus according to claim 1, further comprising
a common power source configured to supply a voltage to both the first and second charging members, wherein
an electrical circuit connected to the common power source includes a common portion from the common power source to a first branch point, a first portion from the first branch point to the first charging member, and a second portion from the first branch point to the second charging member, and
the first portion is provided with a Zener element that sets the first charging voltage applied from the common power source to a level less than a threshold at which the first charging member generates discharge.

16. The image forming apparatuses according to claim 15, wherein
the common power source is provided in a main body of the image forming apparatus, and
the photosensitive drum, the first charging member, the second charging member, and the Zener element are provided in a process cartridge which is detachably provided to the main body of the image forming apparatus.

17. The image forming apparatus according to claim 1, further comprising
a common power source configured to supply a voltage to both the first and second charging members, wherein
an electrical circuit connected to the common power source includes a common portion from the common power source to a first branch point, a first portion from the first branch point to the first charging member, and a second portion from the first branch point to the second charging member, and
the second portion has a second branch point at which the electrical circuit is connected to a capacitor element and a prescribed potential.

18. The image forming apparatuses according to claim 17, wherein
the common power source is provided in a main body of the image forming apparatus, and
the photosensitive drum, the first charging member, the second charging member, and the capacitor element are provided in a process cartridge which is detachably provided to a main body of the image forming apparatus.
